(19) United States
(12) Patent Application Publication
(10) Pub. No.: US 2003/0023495 A1
(43) Pub. Date: Jan. 30, 2003

(54) System for automatically cross-reporting direct transaction information and method of operating same

(76) Inventor: Un-Chong Yi, Daejoen-city (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/204,822

(22) PCT Filed: Feb. 23, 2001
(86) PCT No.: PCT/KR01/00270

(30) Foreign Application Priority Data
Feb. 25, 2000 (KR) 2000-9505

(51) Int. Cl. H04M 11/00; G06F 17/60

(52) U.S. Cl. 705/21; 379/93.12

(57) ABSTRACT

Disclosed is a system for automatically cross-reporting direct transaction information where an ARS telecommunication system is in combination with a network. The system includes an information standardization unit for standardizing the information request input from users through analog telephones, mobile telecommunication device or a cyber display frame on a computer, a control unit for analyzing requirements of the users and searching the required information, an information storage unit classifying the information required for the control unit and storing the required information, and an information transmission unit for receiving the user-oriented information from the control unit and transmitting the information to the users.

### BACKGROUND OF THE INVENTION

(a) Field of the Invention

The present invention relates to a system for automatically cross-reporting direct transaction information where an ARS telecommunication system is in combination with a network to cross-report the information for transaction of goods or services to the consumer and the merchant in an effective manner.

(b) Description of the Related Art

Generally, advertisements for various kinds of information such as global or local shipping information, sales information for cars, daily necessities, or immovable properties, job seeking or offering information, and friendship information are made through a newspaper, a radio, a life information paper, an ARS (audio response system) telecommunication system, or an internet system.

FIG. 1A is a block diagram illustrating a conventional internet system, and FIG. 1B is a block diagram illustrating a conventional ARS telecommunication system.

In the conventional internet system, when a consumer (intending to purchase goods or services) or a merchant (intending to sell goods or services) connects to a web server 10 over a network 20 via a consumer computer 30 or a merchant computer 40, the web server 10 provides a web page to the consumer computer 30 or the merchant computer 40.

However, in such an internet system for one directional information search, the user cannot directly write the requirements on the web page, and should pass through multiple operation steps to obtain the desired information.

Meanwhile, in the conventional ARS telecommunication system, an operator 70 collects information in various fields such as stock and entertainment, and records it at a dialog board built in an ARS server 60. Upon receipt of a request from a user 50, the operator 70 provides the relevant information to the user 50, and charges the user 50 for the information usage fees depending upon the amount of usage time recorded at a time counter 80.

However, in such a conventional ARS telecommunication system, the information provider, on the one hand, cannot collect sufficient amount of information for satisfying the requirements of each user, and the user, on the other, should consume needless time and money for navigating at unnecessary information flow while not obtaining the desired information in a correct manner.

Furthermore, since a system directly interconnecting the consumer and the merchant in a continuous manner when needed is not currently available, the consumer should search for the telephone number of the relevant merchant through many information newspapers and brokers, and the merchant should repeatedly make advertisements while consuming much cost.

In addition, considering that the consumer uses only part of the overwhelming information, most of the advertisements become to be unnecessary while making the merchant to consume much advertisement cost.

### SUMMARY OF THE INVENTION

It is an object of the present invention to provide a system which can report only the necessary information to the consumer and the merchant through determining the kinds or locations of goods or services entering in transaction between the consumer and the merchant, and standardizing the available price and the demand price.

It is another object of the present invention to provide a system which detects the information required for the consumer and the merchant, and automatically provides the detected information to the consumer and the merchant in real time.

It is still another object of the present invention to provide a system which enables the consumer or the merchant to use the required information while regenerating the recorded information even when the transaction between the consumer and the merchant is not made.

These and other objects may be achieved by a system for automatically cross-reporting a direct transaction information where an ARS telecommunication system and a network are combined. The system receives an information request from the user through a communication device or a computer over a communication network, and reports the relevant information to the user.

The system is provided with an information standardization unit for standardizing the information request from the user over the network while displaying a cyber display frame on the screen of the user computer. The cyber display frame contains categories and items of goods and services, classification regions of the consumer and the merchant, cost input regions, and location input regions where direct distance dialing numbers and zip code numbers of relevant countries are present.

A control unit receives the standardized information request from the information standardization unit, analyzes the information request, and searches for the required information within the available range.

An information storage unit classifies, and stores the information required for the control unit as well as code information for the goods and services. The code information contains location codes where the direct distance dialing numbers and the zip code numbers are combined.

An information transmission unit receives the information to be transmitted from the control unit, and transmits the information to the user such that the transmitted information is well adapted for the receipt state of the user.

The information standardization unit is provided with an ARS telephone server receiving the information request from the user in a telephone access, a database converter converting the data received at the ARS telephone server to have the same format as the information input over the network, and a web server providing a web page to the user in a network access such that the web page is displayed on the screen of the user computer.

The information storage unit is provided with a consumer database storing the numbers selected by consumers and the contact numbers of the consumers, a merchant database storing the numbers selected by merchants and the contact numbers of the merchants, a direct distance dialing number database storing the direct distance dialing numbers for the locations where the target goods or services are placed or the desired transactions are willing to be made, a zip code number database storing the zip code numbers for the locations where the target goods or services are placed or the desired transactions are willing to be made, and an audio ment code database storing vocal ment codes to transmit suitable vocal ments to the consumers or the merchants.

The information transmission unit is provided with a receiver detector for detecting the receipt state of the user such that the user can receive the information processed at the control unit in a suitable manner, a media converter for converting the information to be transmitted such that the information is well adapted for the receipt state of the user detected by the receiver detector, and an audio server for vocally transmitting the information converted at the media converter to the user.

The cyber display frame is a determinate frame where the kinds, locations and costs of goods or services are displayed at the cyber space together with the contact communication numbers.

In a method of operating a system for automatically cross-reporting a direct transaction information where an ARS telecommunication system and a network are combined, a form of an information request is provided to the user by way of vocal ments or a web page. The user fills the form with selection numbers at the user in a standardized manner. The selection numbers are related to the kinds of goods or services and the locations thereof.

The selection numbers are coded and stored at the information storage unit, and the relevant information related to the number codes is searched at the information storage unit. The number codes contain direct distance dialing numbers and zip code numbers of relevant countries.

The requested information is reported to an information receipt unit available to the user.

In the step of filling the information request form in a standardized manner, guide ments are issued to the user such that the user selects the categories of goods or services to be transacted, and the locations thereof where the transaction is willing to be made. The user selects specific items belonging to the selected categories, and confirms whether the user is a consumer or a merchant. The user then selects the locations where the transaction is willing to be made. Advertisements are transmitted to the user depending upon the relevant items and the transaction locations. The price for the selected items, and the contact number available to the user are then input.

In the step of reporting the required information to the user, it is possible that the information for the selected items is temporarily stored, and after the requested information is obtained, the information is transmitted to the information receipt unit of the user.

In the step of reporting the required information to the user, it is further possible that advertisements well adapted for the selected items and the locations thereof are provided to the receipt unit of the user.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or the similar components, wherein:

FIG. 1A is a block diagram of an internet system according to a prior art;

FIG. 1B is a block diagram of an ARS telecommunication system according to a prior art;

FIG. 2 is a schematic view of a system for automatically cross-reporting a direct transaction information according to a preferred embodiment of the present invention;

FIG. 3 is a block diagram specifically illustrating the structure of the system shown in FIG. 2;

FIG. 4 is a block diagram of a media converter shown in FIG. 3;

FIG. 5 illustrates the combinational operation of a receiver detector and a media converter shown in FIG. 3;

FIG. 6 illustrates a cyber display frame displayed at a web page in the system show in FIG. 2;

FIG. 7 illustrates the code structure of the consumer and the merchant in the system shown in FIG. 2;

FIG. 8 is a flowchart illustrating the overall operational steps of the system shown in FIG. 2;

FIG. 9 is a flowchart illustrating the search process in the system shown in FIG. 2;

FIG. 10 is a flowchart illustrating the registered information identification process in the system shown in FIG. 2; and

FIG. 11 illustrates the code table for sentences or words in the system shown in FIG. 2.

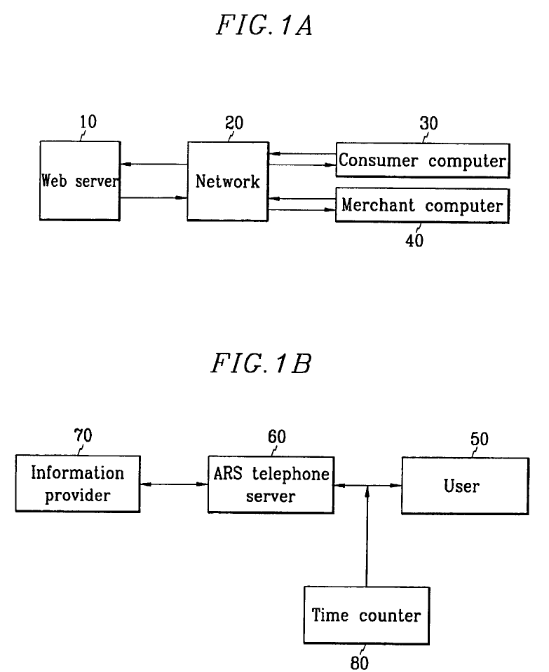

### DETAILED DESCRIPTION OF THE PREFERRED EMBODIMENTS

Preferred embodiments of this invention will be explained with reference to the accompanying drawings.

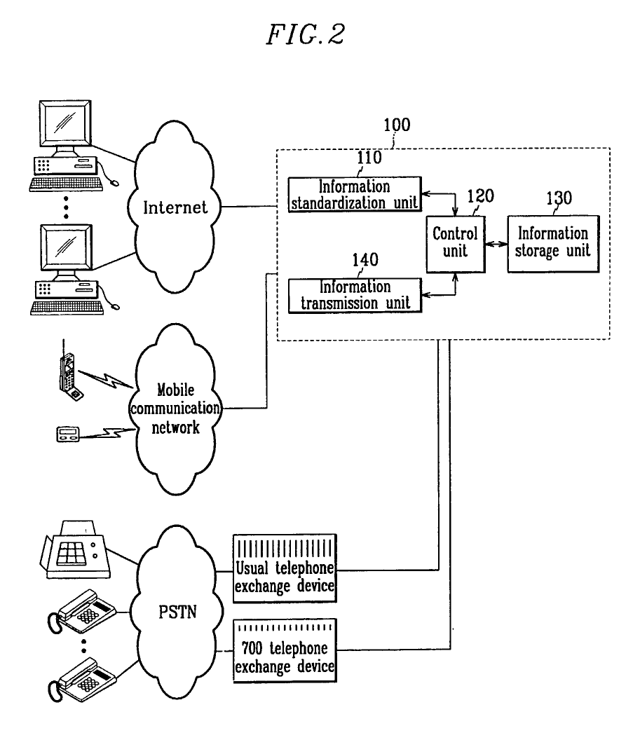

FIG. 2 is a block diagram of a system for automatically cross-reporting direct transaction information according to a preferred embodiment of the present invention.

As shown in FIG. 2, the system 100 is provided with an information standardization unit 110 for standardizing the information request input from the user communication equipment such as a computer, a portable telephone, a wired telephone and a fax over the Internet, mobile communication network, or public switched telephone network (PSTN). A control unit 120 receives the standardized information request from the information standardization unit 110, analyzes the requirements of the user from the received information request, and searches for the required information. An information storage unit 130 classifies, and stores the information required for the control unit 120. An information transmission unit 140 receives the information request from the control unit 120, and transmits the required information to the user.

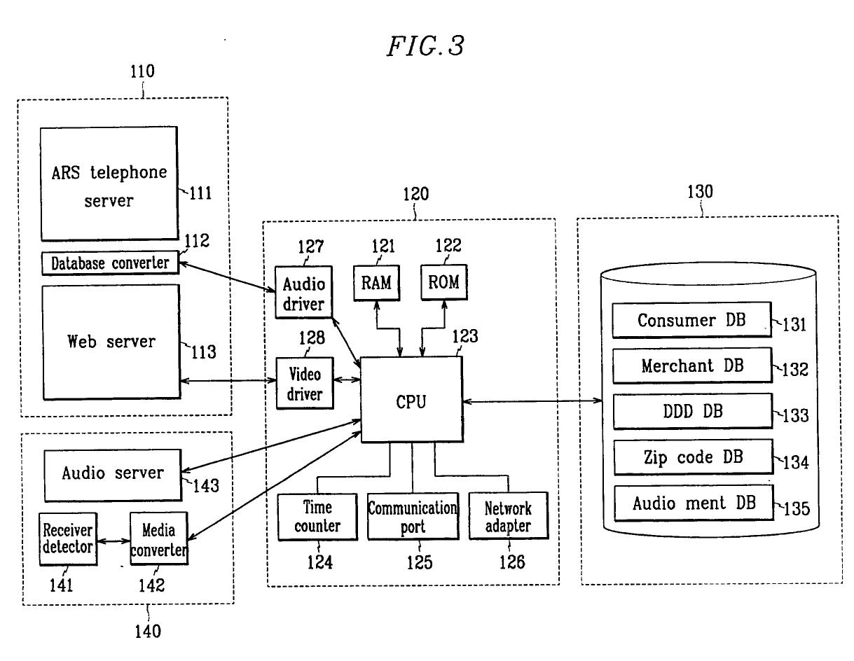

FIG. 3 specifically illustrates the structure of the system shown in FIG. 2.

As shown in FIG. 3, the information standardization unit 110 includes an ARS telephone server 111 receiving the information request from the user in the telephone-based access, a database converter 112 converting the data input through the ARS telephone server 111 to have the same form as the information input over the Internet, and a web server 113 providing a web page to the user computer in the Internet-based access.

The control unit 120 includes a RAM 121 where the number selected by the user is temporarily stored, a ROM 122 where an operation system program is stored, a CPU 123 controlling the flow of information upon receipt of the information request from the user while issuing signals of recording and calling information at the information storage unit 130, a time counter 124 counting and recording the amount of usage time in the user access for the CPU 123, a communication port 125 communicating with the user computer, a network adapter 126 connecting to the Internet, an audio driver 127 issuing audio ments depending upon the selection number input through the ARS telephone server 111, and a video driver 128 displaying video images on the web page depending upon the selection items input though the web server 113.

The control unit 120 may include an ethernet card for communicating with the user over the Internet. An ethernet card having a capacity of 10 MB or 100 MB manufactured by Metcalfe and Boggs companies may be used for that purpose.

The control unit 120 has a role of database management system (DBMS). The DBMS is a software package that makes addition, variation, deletion, or searching of the data required for managing the database. The DBMS operates between the user application programs and the database shared by many users to call out the required information from the database on demand, and record or store information at the database.

The information storage unit 130 includes a consumer database 131 where the selection numbers and the telephone numbers of the consumers are stored, a merchant database 132 where the telephone numbers of the merchants are stored, a location number code database 133 where the number codes for the location of goods or services to be transacted are recorded, a zip code number database 134 where the zip code numbers for the location of goods or services to be transacted are recorded, and an audio ment code database 135 where the audio ment codes are stored.

The information storage unit 130 is provided with a hard disc or a CD-ROM to support various forms of databases.

The information transmission unit 140 includes a receiver detector 141 for detecting the information receipt state of the receiver, a media converter 142 for converting the resulting information to be adapted for the detected receipt state of the receiver, and an audio server 143 for vocally providing the converted information to the user.

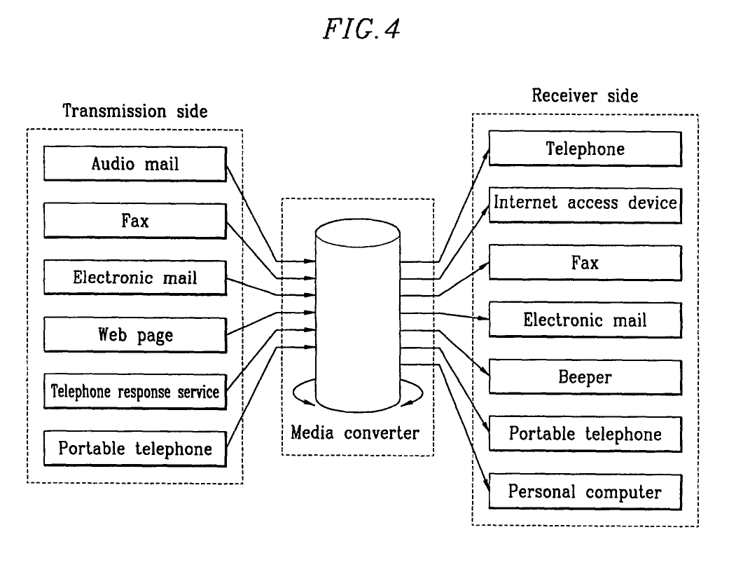

FIG. 4 specifically illustrates the media converter shown in FIG. 3.

As shown in FIG. 4, the media converter 142 converts the information request input through the user telecommunication device such as a telephone, a fax, an electronic mail, a beeper, a portable telephone, and a personal computer to have a form that can be processed at the CPU 123.

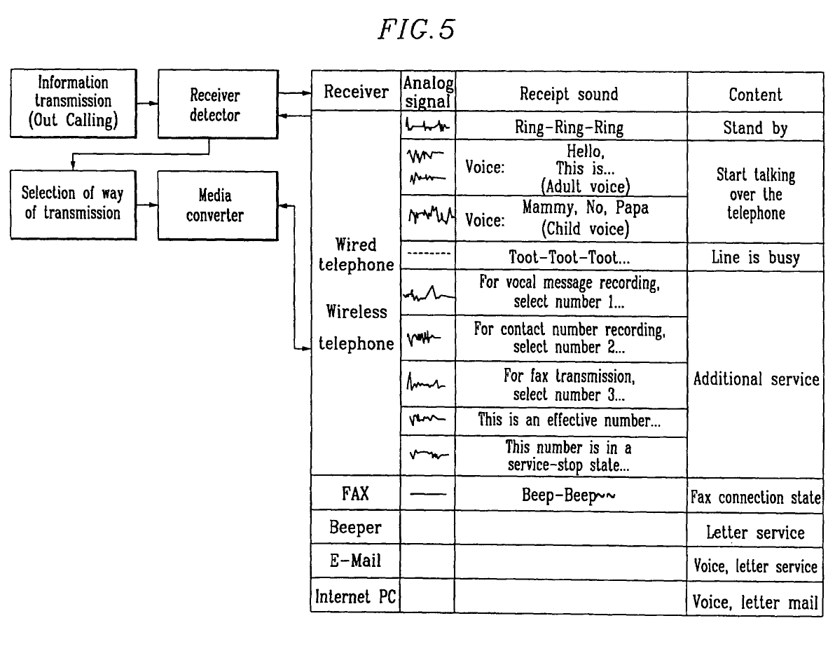

FIG. 5 illustrates the operational relation of the receiver detector to the media converter shown in FIG. 3.

As shown in FIG. 5, in order to transmit the requested information to the user, the receipt state of the user is detected by the receiver detector 141, and analog signal is transmitted to the user via the media converter 142 depending upon the detected receipt state of the user. For example, in case the user is in a state capable of receiving the required information through a wired telephone, the analog signal adapted for the wired telephone is transmitted to the user, and the user hears the vocal message corresponding to the analog signal.

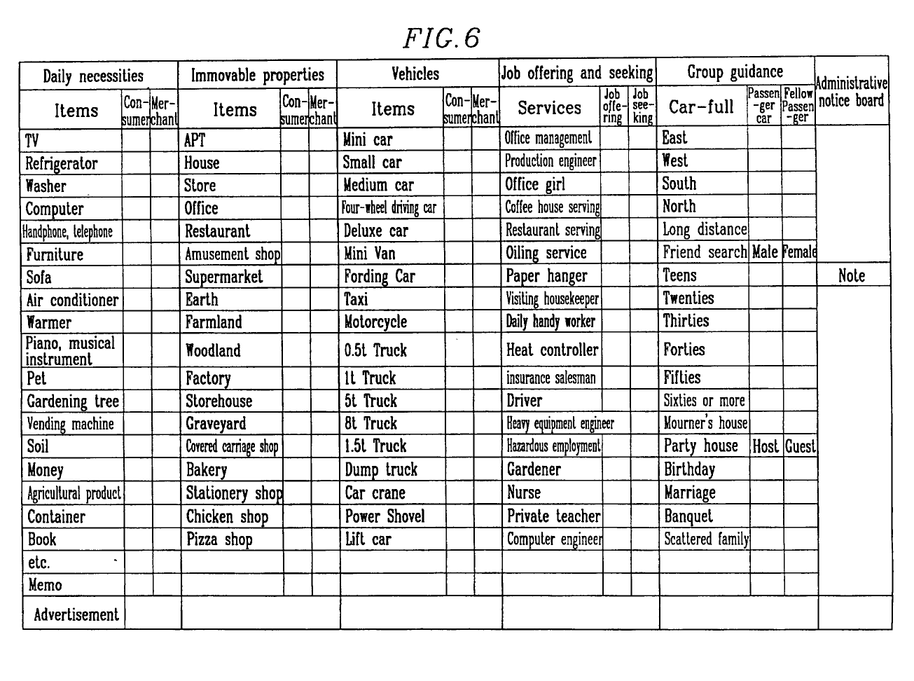

FIG. 6 illustrates a cyber display frame displayed on a web page in the system shown in FIG. 2.

When the user computer connects to the web server 113 through driving the built-in web browser, the cyber display frame is displayed at the computer screen. The cyber display frame is a frame where various kinds of goods or services to be transacted are displayed in the cyber space based on the Internet.

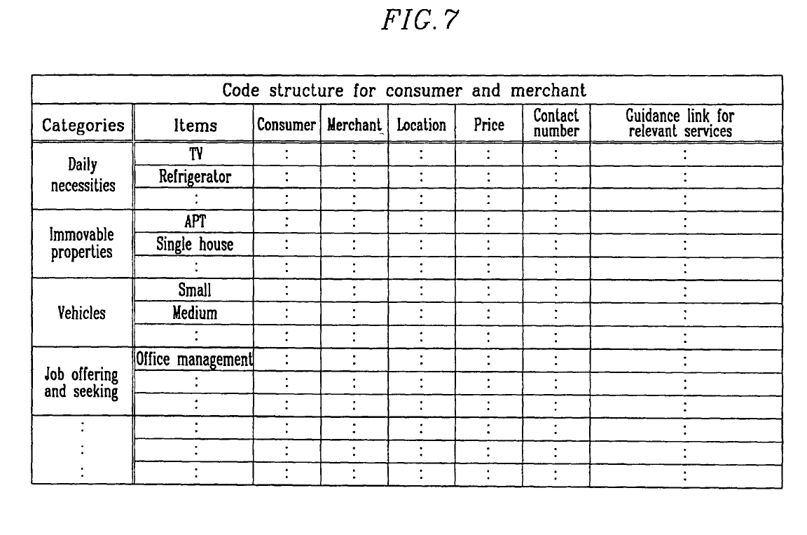

FIG. 7 illustrates the code structure for the consumer and the merchant in the system shown in FIG. 2. The codes corresponding to the selection numbers or fields input by the user through the telephone or the computer are displayed at the relevant positions.

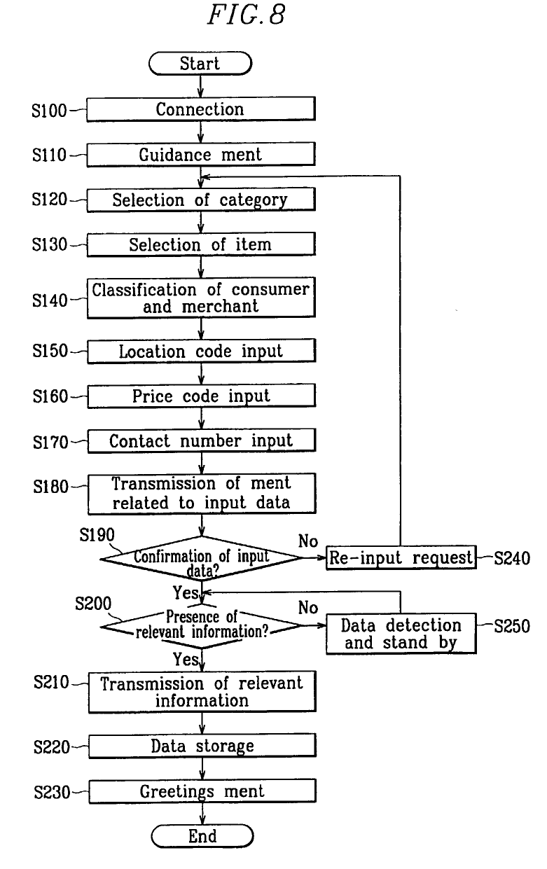

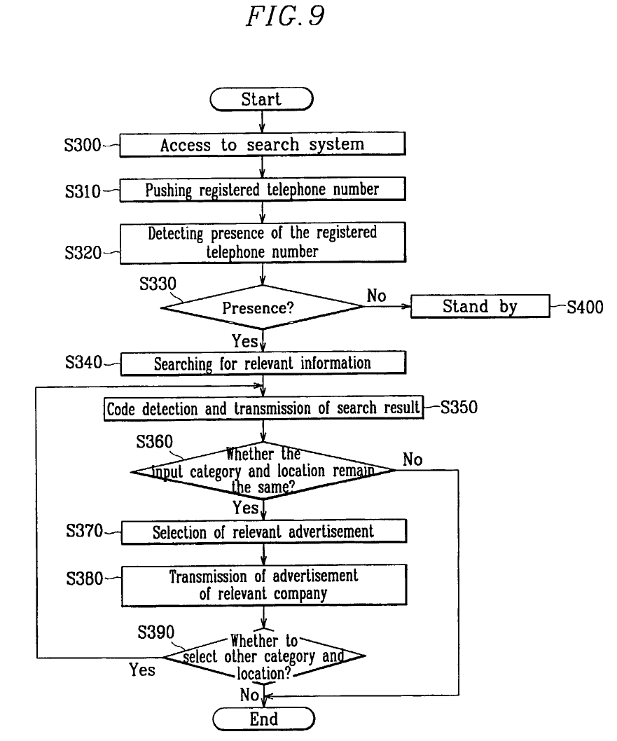

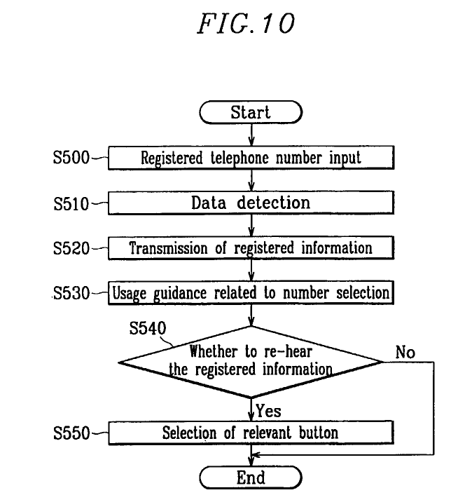

FIG. 8 is a flowchart illustrating the overall operational steps of the system shown in FIG. 2, FIG. 9 is a flowchart illustrating the information search process in the system, and FIG. 10 is a flowchart illustrating the registered information identification process in the system.

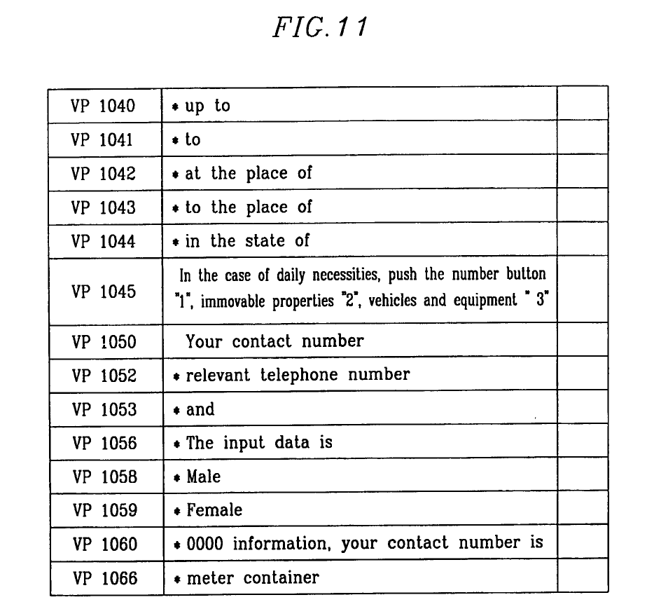

FIG. 11 illustrates the combinational codes for the sentences and words used in the system. As shown in FIG. 11, the forms of information transmission to the user are coded depending upon the dial numbers or the selection fields input by the user, and the audio ments corresponding to each code are transmitted to the user.

The operation of the system for automatically cross-reporting the direction transaction information will be now explained with reference to FIG. 8.

When the user connects to the ARS telephone server 111 of the information standardization unit 110 through a usual telephone or a mobile communication device (S100), the audio driver 127 issues usage guide vocal ments to the user (S110).

In case the user connects to the web server 113 over the Internet, a web page is displayed at the user computer. The user selects the desired items on the web page.

In order to select the desired items on the web page, the user may write the relevant numbers or letters on the web page via a keyboard, or use a mouse for the selection. Access to the web server 113 may be made via an internet service provider (ISP), but not limited thereto.

The user hears vocal ments through a speaker (not shown), and selects the relevant category through writing the relevant number by the guidance of vocal ments (S120). For example, the number “1” may be attributed to the daily necessities, “2” to the immovable properties, and “3” to the vehicles. The selected number is input into the CPU 123 via the database converter 112, and the CPU 123 temporarily stores the input number at the RAM 121.

When the user selects the relevant category, the detailed number information with respect to the items belonging to the category is transmitted to the user. The user selects the desired item numbers, and pushes the button “#” when the number selection is completed (S130).

When the user connects to the web server 113 by way of a user computer, the user writes the desired item number on the web page. For example, guidance vocal ments to the effect that the television is indicated by “1” and “#”, the refrigerator by “2” and “#”, and the washer by “3” and “#” are transmitted to the user, and the user pushes the relevant buttons for the selection.

Two-placed number codes are assigned to the items of goods or services.

The user then pushes the number buttons for classifying the consumer and the merchant by the guidance of subsequent vocal ments (S140).

When the user connects to the web server 113 by way of a user computer, the user writes the relevant numbers on the web page. For example, the consumer may select the number “1” while the merchant selecting the number “2.”

One-placed number codes are assigned to the consumer and the merchant.

When the user inputs codes for the location where the consumer or merchant intends to purchase or sell the selected items by the guidance of vocal ments, the relevant advertisement ments or the relevant advertisement screen images are transmitted to the user depending upon the selected items and the location thereof (S150). For example, the location code may contain a four-placed number of direct distance dialing (DDD) for the place of purchasing or selling the daily necessities or immovable properties or the place of departure or arrival of vehicles, and a six-placed number of zip code thereof. Furthermore, the nation code may be used together with the DDD number. In case the target transaction is made in Seoul, the buttons “O2” and “#” may be pushed together. In case the target transaction is made in Kangnamku, Seoul, the buttons “135” and “#” may be pushed together. In foreign countries, when the target transaction is made in Alabama, U.S.A, the location code may be obtained through combining the U.S. code “1” and the Alabama code “205.” With the selection of such a location code, the user hears advertising ments through the telephone, or the relevant advertisements are displayed on the screen of the user computer.

Price codes for the selected items are input by the guidance of vocal ments (S160). In order to simplify the standardization, the price code varies in input unit depending upon the relevant categories. That is, in the category of life necessaries, since the price thereof is relatively low, the price code may be established to be a two-placed number. In the category of immovable properties, since the price thereof is relatively high, the price code may be established to be a five-placed number.

The available price and volume of the immovable property between the consumer and the merchant may be fluently determined while being varied in the range of about 20% error. The information adapted for the determined values is detected, and the detected information is transmitted to the user.

Finally, the contact number code of the user is input by the guidance of relevant vocal ments (S170). Usually, a data structure with a twenty-placed number is required for the user contact number code. The user contact number code may include a telephone number, an electronic mail address, a fax number, and a beeper call number, but not limited thereto.

The numbers input by the user are recorded and stored at the information storage unit 130 in accordance with the consumer and merchant code structure shown in FIG. 7. The CPU 123 of the control unit 120 analyzes the numbers input by the user, and transmits the relevant vocal ments to the user (S180). The user in turn hears the vocal ments, and confirms whether the input numbers are correct.

Upon confirmation of the input data by the user (S190), the CPU 123 of the control unit 120 identifies whether the relevant information is present in the information storage unit 130 (S200), and, if yes, provides the information to the user (S210).

The category and location codes for the goods or services as well as the guidance codes for the provider companies are stored at the information storage unit 130 in the same format. Therefore, in case the same code as that required for the user is stored at the information storage unit 130, the relevant information is called out, and transmitted to the user.

If the output information is not the one the user intends to obtain, the button “*” may be selected. In case it is intended to receive guidance of the relevant merchant company, the button “8” may be selected. In case it is intended to receive usage guide for the relevant information, the button “9” may be selected.

In the step of receiving the relevant information, when the user judges that the required information for the target goods or service is all obtained, the user may push the button “#.” At this time, the data input by the user so far are all stored at the information storage unit 130 (S220).

When the user receives all of the desired information, greetings ments are issued while informing the end of connection to the system to the user (S230).

The process of searching the relevant information after the registration of the user telephone number will be now explained with reference to FIG. 9.

The user connects to a search system through a telephone or over the Internet (S300), and pushes the registered telephone number, and the “#” button (S310). The selected telephone number is input to the CPU 123 through the ARS telephone server 111, the audio driver 127, and the database converter 112. The CPU 123 temporarily stores the input telephone number at the RAM 121.

When the user connects to the search system over the Internet through executing the web browser, the relevant number is input into the CPU 123 through the web server 113, and the video driver 128.

The CPU 123 searches the input number information at the registered telephone numbers, and identifies whether the relevant number information is present (S320). If yes, it detects the information codes corresponding to the relevant telephone number (S330-S340), and, pursuant to the search result, informs vocal or image information to the user (S350).

The user hears or sees the vocal or image information, and selects the information hearing related to the relevant company by way of the ARS telecommunication. The CPU 123 judges whether the previously input category and location of goods or service remains the same (S360). If yes, it searches the relevant advertisements, and selects those corresponding to the relevant category and location of goods or services (S370), and transmits the advertisements of the related company to the user via the ARS telephone (S380).

In case the user connects to the system by way of a user computer, the CPU 123 identifies the category and location of goods or services, and makes the web browser of the user computer to access to the relevant advertisements. When the user clicks the desired advertisement, a web hosting advertisement document formatted in HTML is transmitted to the web browser of the user computer. Programs or algorithms such as Netscape navigator, MAC, RIPE-MAC, and CBC may be used in order that when the user stops access to or inputs other category or location codes, the corresponding advertisements should be transmitted to the user.

For instance, in case the user makes transaction for a television in Kangnamku, Seoul, the number code may be “13511” where the zip code “135” of Kangnamku, the category code “1” for the daily necessities, and the item code “1” for the television are combined. In this case, the vocal ment advertisement corresponding to the voice packet (VP) code “VP13511” is transmitted to the user via the ARS telephone, or a web page image advertisement corresponding to the internet voice packet (IVP) code “IVP13511” is displayed at the user computer screen.

When the user intends to search for other category and location of goods or services (S390), the user can make the search by the guidance of relevant vocal ments.

A method of identifying the registered information through the registered telephone number by the user will be now explained with reference to FIG. 10.

When the user intends to discriminate the connection telephone number, the user input the registered telephone number, and pushes the “#” button (S500). The CPU 123 searches the input telephone number at the information storage unit 130 (S510), and transmits the registered information related to the telephone number to the user by way of vocal ments (S520). Upon receipt of the vocal ments, the user can select the relevant function keys by the guidance of vocal ments (S530). For instance, when the number button “8” of the dial is pushed, the user can obtain the service for the relevant companies related to the selected category and location codes. When the number button “9” of the dial is pushed, the user can obtain guidance for the subsequent services by way of vocal ments.

When it is intended to re-hear the registered information, the user may push the “*” button of the dial to thereby re-hear the vocal ments at the step (S520) of transmitting the registered information (S540-S550).

As described above, in the system for automatically cross-reporting the direction transaction information where the ARS telecommunication system and the network are combined, a public electronic medium is provided such that the transaction circulation information for the usual items of goods or services are standardized for the consumer and the merchant in the same format to thereby interconnect the consumer and the merchant in a simplified manner, and the required information can be extensively circulated in an effective manner. In such a communication system, the telephone, the ARS telephone server, and the wired or wireless communication devices can be combined in an efficient manner.

Furthermore, the kinds or categories of goods or services as well as the locations where the goods or services are placed or it is intended to make transaction are previously established between the consumer and the merchant, and the available price and the demand price are standardized so that only the information necessary for the consumer and the merchant can be automatically given to them in real time to be adapted for their receipt states.

In addition, when the transaction between the consumer and the merchant is not made but they want other information, the registered information can be recovered for use.

Furthermore, as the information is continuously stored during the predetermined time interval in a stand-by state, the user can make search for scattered family or friends in an effective manner.

In the case of freight or container transportation, the circulation between neighboring countries or local areas is facilitated so that the transportation cost is decreased while reducing the required energy, resulting in vehicle efficiency and traffic advantages.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A system for automatically cross-reporting a direct transaction information where an ARS telecommunication system and a network are combined, the system receiving an information request from the user through a communication device or a computer over a communication network and reporting the relevant information to the user, the system comprising:
an information standardization unit for standardizing the information request from the user over the network while displaying a cyber display frame on the screen of the user computer, the cyber display frame comprising categories and items of goods and services, classification regions of the consumer and the merchant, cost input regions, and location input regions where direct distance dialing numbers and zip code numbers of relevant countries are present;
a control unit receiving the standardized information request from the information standardization unit, analyzing the information request, and searching for the required information within the available range;
an information storage unit for classifying and storing the information required for the control unit, and storing code information for the goods and services, the code information comprising location codes where the direct distance dialing numbers and the zip code numbers are combined; and
an information transmission unit receiving the information to be transmitted from the control unit, and transmitting the information to the user such that the transmitted information is well adapted for the receipt state of the user.

2. The system of claim 1 wherein the information standardization unit comprises:
an ARS telephone server receiving the information request from the user in a telephone access;
a database converter converting the data received at the ARS telephone server to have the same format as the information input over the network; and
a web server providing a web page to the user in a network access such that the web page is displayed on the screen of the user computer.

3. The system of claim 1 wherein the information storage unit comprises:
a consumer database storing the numbers selected by consumers and the contact numbers of the consumers;
a merchant database storing the numbers selected by merchants and the contact numbers of the merchants;
a direct distance dialing number database storing the direct distance dialing numbers for the locations where the target goods or services are placed or the desired transactions are willing to be made;
a zip code number database storing the zip code numbers for the locations where the target goods or services are placed or the desired transactions are willing to be made; and
an audio ment code database storing vocal ment codes to transmit suitable vocal ments to the consumers or the merchants.

4. The system of claim 1 wherein the information transmission unit comprises:
a receiver detector for detecting the receipt state of the user such that the user can receive the information processed at the control unit in a suitable manner;
a media converter for converting the information to be transmitted such that the information is well adapted for the receipt state of the user detected by the receiver detector; and
an audio server for vocally transmitting the information converted at the media converter to the user.

5. The system of claim 1 wherein the cyber display frame is a determinate frame where the kinds, locations and costs of goods or services are displayed at the cyber space together with the contact communication numbers.

6. A method of operating a system for automatically cross-reporting a direct transaction information where an ARS telecommunication system and a network are combined, the system receiving an information request from the user through a communication device or a computer over a communication network and reporting the relevant information to the user, the method comprising the steps of:
providing a form of an information request to the user by way of vocal ments or a web page, and filling the form with selection numbers at the user in a standardized manner, the selection numbers being related to the kinds of goods or services and the locations thereof;
coding the selection numbers, storing the number codes at the information storage unit, and searching for the relevant information related to the number codes at the information storage unit, the number codes comprising direct distance dialing numbers and zip code numbers of relevant countries; and
reporting the required information to an information receipt unit available to the user.

7. The method of claim 6 wherein the step of filling the information request form in a standardized manner comprises the sub-steps of:
issuing guide ments to the user such that the user selects the categories of goods or services to be transacted, and the locations thereof where the transaction is willing to be made;
selecting specific items belonging to the selected categories at the user;
selecting whether the user is a consumer or a merchant;
selecting the locations where the transaction is willing to be made, and transmitting advertisements to the user depending upon the relevant items and the transaction locations; and
inputting the price for the selected items, and the contact number available to the user.

8. The method of claim 6 wherein the step of reporting the required information to the user comprises the sub-steps of temporarily storing the information for the selected items, and after the required information is obtained, reporting the information to the information receipt unit of the user.

9. The method of claim 8 wherein the step of reporting the required information to the user further comprises the sub-step of providing advertisements well adapted for the selected items and the locations thereof to the receipt unit of the user.
